(19) United States
(12) Patent Application Publication
(10) Pub. No.: US 2007/0169882 A1
(43) Pub. Date: Jul. 26, 2007

(54) Method and device for fixing clothes hanger hooks

(76) Inventor: Hermann H. Bode, Ochtrup (DE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/598,452

(22) PCT Filed: Mar. 12, 2005
(86) PCT No.: PCT/EP05/02658

§ 371 Date: Aug. 31, 2006

(30) Foreign Application Priority Data
Mar. 17, 2004 (EP) 04006334.9

(51) Int. Cl. B32B 37/12

(52) U.S. Cl. 156/305; 156/578

(57) ABSTRACT

The present invention describes a method and a device provided for carrying out said method for fixing, in particular for re-fixing, clothes hanger hooks (12) in a clothes hanger body (11), whereby clothes hanger hook (12) is wetted, in particular in the region of a clothes hanger hook stem (13), with an adhesive (17) adhesive (17) penetrates a gap (20) between clothes hanger hook (12) and clothes hanger body (11) in the region of a connecting point between clothes hanger hook (12) and clothes hanger body (11) such that the clothes hanger hook is glued in clothes hanger body (11).

### STATEMENT OF RELATED APPLICATIONS

This patent application is the US National Phase of PCT/EP2005/002658 having an International Filing Date of 12 Mar. 2005 (Mar. 12, 2005), which was published under International Publication No. WO 2005/092157 A1 on 6 Oct. 2005, which in turn claims priority on European Patent Application No. 04006334.9, which has a filing date of 17 Mar. 2004 (Mar. 17, 2004).

### BACKGROUND OF THE INVENTION

1. Technical Field

The invention relates to a method and a corresponding device for fixing, in particular for re-fixing clothes hanger hooks in a clothes hanger body.

2. Prior Art

Clothes hangers are generally familiar. They are known to include a clothes hanger body to hang up items of clothing and a clothes hanger hook attached to the clothes hanger body by means of which the clothes hanger itself is hung up.

Clothes hangers, particularly simple and low-cost clothes hangers, are used for the purpose of presentation when selling items of clothing. When an item of clothing is bought, the clothes hanger is normally removed from the purchased item of clothing at the till area and reused. When reusing clothes hangers, it must, among other things, be ensured that the clothes hanger hook is fixed in the clothes hanger body to a sufficient extent, i.e. the clothes hanger hook must be connected to the clothes hanger body in a manner such that it can still bear the appropriate load and the clothes hanger hook must not be able to rotate too easily in the clothes hanger body.

The clothes hanger hook is normally aligned parallel to the clothes hanger body. In this position, a plurality of items of clothing can be arranged beside each other, each on a clothes hanger, in the familiar manner on rails or the like. When the customer picks up the item of clothing along with the corresponding clothes hanger, it often occurs that the clothes hanger hook is rotated by approx. 90° in the clothes hanger body and the item of clothing is hung up again. This means that the customer can still clearly see the item of clothing selected or chosen for further consideration for comparison and the like. However, such movements of the clothes hanger hook often lead to the fixing of the clothes hanger hook in the clothes hanger body coming loose.

This represents a particular disadvantage when such a clothes hanger is reused and an item of clothing located on such a clothes hanger is moved in automatic transporting or sorting systems. In such systems, clothing is moved at high speeds while hanging on clothes hangers. Moreover, the systems are set up such that items of clothing are moved in a parallel direction to each other. The parallel alignment of the items of clothing in relation to each other is ensured by means of a corresponding alignment of the clothes hangers carrying the items of clothing. Such an alignment of the clothes hangers can, in turn, only be achieved if the clothes hanger hooks and clothes hanger bodies are aligned parallel to each other and there is only minimal movability of the clothes hanger hook in the clothes hanger body.

Such minimal movability can often not be ensured, i.e. the movability is above such a minimal level of movability, if the clothes hanger hook has been manually twisted. Hitherto, such clothes hanger hooks have had to be identified and removed, resulting in a significant outlay. This is disadvantageous due to the costs involved. Further disadvantageous costs also arise due to the fact that a removed clothes hanger has to be replaced with a new clothes hanger with a clothes hanger hook which is fixed in a sufficiently rigid manner.

However, if unsuitable clothes hangers are not removed, the clothes hanger body may rotate relative to the clothes hanger hook during transport in automatic transporting or sorting systems such that the desired parallel alignment of the items of clothing is no longer ensured. The automatic handling steps in the transporting and sorting systems are, however, based on this parallel alignment such that incorrect alignment can result in damage to the clothing or the transporting and sorting systems or components thereof. Due to the high operating speeds, a number of items of clothing can be affected by such damage. Damage to the system can result in significant downtime until the damage has been repaired. These disadvantages are obviated or at least reduced by the invention.

### BRIEF SUMMARY OF THE INVENTION

The object of the invention is therefore to describe a method and a device suitable for carrying out the method, whereby clothes hangers, in particular used clothes hangers, can be suitably handled such that specific properties are satisfied in terms of the movability (rotatability) of the clothes hanger hook in the clothes hanger body.

According to the invention, this object is solved in terms of the method for fixing, in particular for re-fixing, clothes hanger hooks in a clothes hanger body, characterized in that the clothes hanger hook is wetted, in particular in the region of a clothes hanger hook stem, with an adhesive and in that, in the region of a connecting point between clothes hanger hook and clothes hanger body, the adhesive penetrates a gap between clothes hanger hook and clothes hanger body. For this purpose, a method for fixing, in particular for re-fixing, clothes hanger hooks in a clothes hanger body provides that the clothes hanger hook is wetted, in particular in the region of a clothes hanger hook stem, with an adhesive and, in the region of a connecting point between clothes hanger hook and clothes hanger body, the adhesive penetrates a gap between clothes hanger hook and clothes hanger body. The clothes hanger hook is thus glued together with the clothes hanger body.

In terms of the device, the abovementioned object is solved according to the invention by a device for fixing, in particular for re-fixing, clothes hanger hooks in a clothes hanger body of a clothes hanger, with an adhesive applicator which comprises a pipette and which is assigned to a transporting device for transporting clothes hangers, the pipette being positioned with its free end in the region of the path of movement of the clothes hangers in such a manner that, during the transporting of the clothes hangers, the pipette with a free end successively in each case touches a clothes hanger hook. For this purpose, a device for fixing, in particular for re-fixing, clothes hanger hooks in a clothes hanger body of a clothes hanger is provided, comprising an adhesive applicator which comprises a pipette and which is assigned to a transporting device for transporting clothes hangers, the pipette being positioned with its free end in the region of the path of movement of the clothes hangers in such a manner that, during the transporting of the clothes hangers, the pipette with its free end successively in each case touches a clothes hanger hook.

To the best of the applicant's knowledge, the gluing of clothes hanger hooks to the clothes hanger body has not hitherto been considered. In retrospect, this may be due, firstly, to the associated outlay on costs when using an additional material, namely the adhesive, and, secondly, to a feared visual or haptic impairment of a clothes hanger treated with adhesive.

Instead of gluing, which obviously has not been considered, it has hitherto been attempted to re-fix the clothes hanger hook in the clothes hanger body by heating, by means of ultrasound or by using induction processes. This is disadvantageously time-consuming and, in comparison retrospectively, unfavourable insofar as a significantly higher number of clothes hangers can be dealt with in the same time by gluing.

The advantage of the invention lies in the fact that the clothes hanger can be reused by gluing the clothes hanger hook onto the clothes hanger body since the clothes hanger hook is fixed in the desired preferably parallel direction to the clothes hanger body by means of gluing and the gluing prevents undesirable twisting. The glued clothes hanger hook can still be rotated in the clothes hanger body so that the end customer is not aware when selecting clothing that the clothes hanger has been reused. The force required to twist the clothes hanger hook is, however, so large that there is no risk of such twisting during automatic transporting of clothes hangers with clothing attached thereto.

Advantageous embodiments of the invention are the subject matter of the dependent claims.

A pipette is particularly suitable for applying the adhesive to the clothes hanger hook. Preferably, in the case of such a pipette, the free end, namely the end with an outlet opening for the adhesive, is elastic.

In order to apply the adhesive to the clothes hanger hook, it is accordingly provided that the pipette preferably touches the clothes hanger hook in the region of a clothes hanger hook stem. The clothes hanger hook stem is a straight or substantially straight section below the actual hook on the clothes hanger hook. At the clothes hanger hook stem, the adhesive can flow downwards in the direction of the remaining gap in the region of the connecting point between clothes hanger hook (stem) and clothes hanger body. In the case of automatic application of the adhesive using a device intended for this purpose, the application of the adhesive to the clothes hanger hook stem also has the advantage that various types, in particular various sizes, of clothes hangers can be processed with the same device. Positioning the pipette in alignment with a centre of the clothes hanger hook stem in the case of standard clothes hangers also enables processing of clothes hangers with shorter or longer clothes hanger hook stems. Moreover, if the free, elastic end of the pipette is positioned and aligned in such a manner that an overcrossing with the clothes hanger hook stem is produced, wetting of the clothes hanger hook stem is also ensured in the case of oscillating clothes hangers.

The adhesive used is preferably a capillary flowable adhesive. Such an adhesive is particularly suitable for penetrating the remaining gap at the connecting point between the clothes hanger hook (stem) and clothes hanger body. A capillary flowable adhesive, which hardens faster during capillary action than in the ambient air, is particularly preferably used in this case. The liquid adhesive can then move in the direction of the gap without rapid hardening. Relatively rapid hardening subsequently takes place in the gap such that the desired fixing of the clothes hanger hook is achieved. As a result of the capillary flowability of the adhesive, the quantity of adhesive required is minimized, which is advantageous given the not insignificant costs of such a capillary flowable special adhesive. The remaining adhesive on the clothes hanger hook can be wiped off if required. It is, however, more advantageous to wait for complete hardening of the adhesive before reusing the clothes hanger hook treated in this manner such that the adhesive remaining on the clothes hanger hook cannot be seen or felt.

The capillary flowability of the plastic is particularly advantageous in situations where twisting of the clothes hanger hook in the clothes hanger body has resulted in a quantity of plastic powder within the body. Particularly small cavities form between these powder particles and the clothes hanger hook or the clothes hanger body and are filled by the capillary flowable adhesive. Therefore, the plastic powder produced as a result of the damage to the clothes hanger during twisting of the clothes hanger hook also helps to ensure secure re-fixing of the clothes hanger hook.

A further beneficial effect in connection with the use of the capillary flowable adhesive lies in the fact that, in the case of a glued clothes hanger hook, the momentary gluing is broken during twisting but only a minimal gap is produced, said gap being closed again to a certain extent by the adhesive due to the remaining residual viscosity. This results in a “self-healing effect” to a certain extent for loosened re-fixable clothes hanger hooks.

An embodiment of the invention is described below in greater detail with reference to the drawing. Corresponding items or elements are provided with the same reference numbers in all the figures.

### BRIEF DESCRIPTION OF THE DRAWINGS

FIG. 1 shows a clothes hanger and a pipette as part of an adhesive applicator not shown in further detail.

FIG. 2 shows a detail of the clothes hanger in the region of a connecting point between hook and body of the clothes hanger and the situation immediately before application of the adhesive.

FIG. 3 shows the detail of the clothes hanger with applied adhesive which flows into a gap at the connecting point between hook and body of the clothes hanger and glues the hook in the body there.

### DETAILED DESCRIPTION OF THE PREFERRED EMBODIMENTS

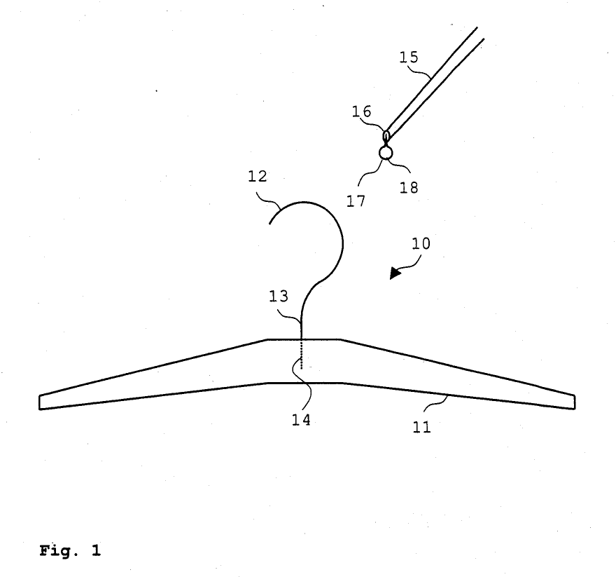

FIG. 1 shows a clothes hanger 10 with a clothes hanger body 11 and a clothes hanger hook 12. Clothes hanger body 11 and clothes hanger hook 12 are referred to below in short as body 11 and hook 12 respectively. Hook 12 is normally manufactured from a metal material, while body 11 is manufactured from a plastic or the like, possibly also from wood or metal. Hook 12 and body 11 are connected to each other, whereby hook 12 partially penetrates body 11 in the region of a clothes hanger hook stem 13, referred to below in short as stem 13. The further course of stem 13 extending inside body 11 is shown by dashed line 14. Body 11 and hook 12 are connected to each other during manufacture. In the case of standard clothes hangers 10 with a body 11 manufactured from plastic, hook 12 is already connected to body 11 at the stage when body 11 is manufactured by injection moulding. When the material from which body 11 is manufactured hardens, hook 12 is fixed therein. To ensure improved fixing of hook 12 in body 11, it is often provided that the hook is corrugated or roughened at the lower end located within body 11 or otherwise comprises a surface contour which makes it more difficult to twist hook 12 in body 11.

However, when using such clothes hangers 10, it is still often the case that hook 12 is twisted in body 11. This destroys the internal connection between hook 12 and the material of body 11 such that hook 12 is often easy to rotate. The ease with which hook 12 can be rotated runs contrary to the reusability of clothes hanger 10 because, in the case of such impaired clothes hangers 10, the transport of clothing on said hangers 10 is not ensured in an alignment parallel to each other with sufficient security. The invention therefore aims to improve the reusability of said clothes hangers 10 by gluing clothes hanger hook 12 in clothes hanger body 11. This does not happen in the case of a device, not shown in further detail, comprising an adhesive applicator, which ends in a pipette 15. The adhesive applicator also includes an adhesive container with a supply of adhesive contained therein. The device is generally suitably mounted by mechanical means and assigned to a transporting device for transporting hanging clothes hangers 10, thereby enabling successive gluing of a plurality of clothes hangers 10 moved past the device one after the other. In a familiar manner, pipette 15 comprises at a free end an opening 16 from which an adhesive 17 escapes in the form of an adhesive drop 18.

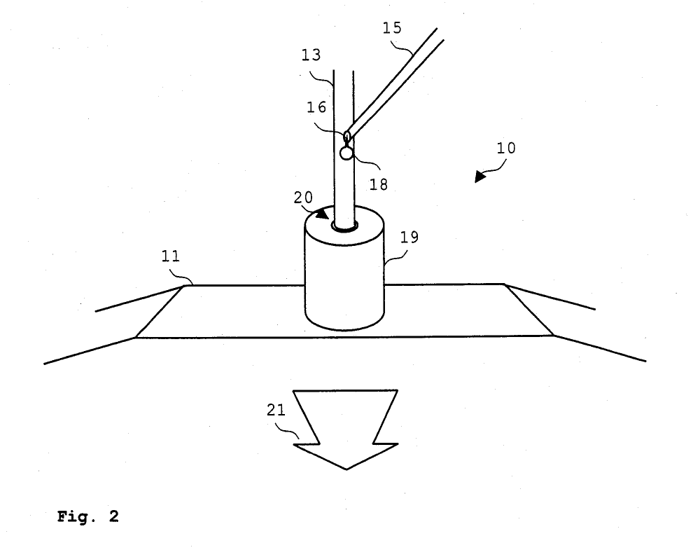

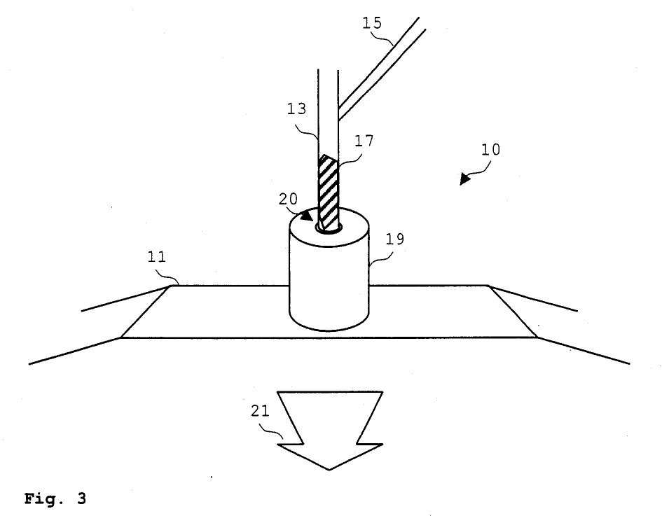

The gluing of hook 12 in body 11 will now be explained more precisely in relation to FIGS. 2 and 3.

FIG. 2 shows a detail of clothes hanger 10 in the region of the connecting point between hook 12 and body 11. Only the lower portion of hook 12, namely clothes hanger hook stem 13, is shown. In the illustration, body 11 comprises a cylindrical bushing 19. In the case of clothes hangers 10 of other types, such a bushing 19 is not present. Bushing 19 as such is otherwise of no relevance to the invention. A gap 20 opens between stem 13 and body 11, in the illustration at the upper end of bushing 19. Gap 20 continues within body 11 along the material border between hook 12 and the material of body 11. To ensure secure gluing of hook 12 to body 11, adhesive 17 must reach said gap 20. For this purpose, in the case of fixed pipette 15, more precisely in the case of a fixed adhesive applicator, clothes hanger 10 is moved past the pipette. The direction of movement of clothes hanger 10 is shown by arrow 21. In the illustration, clothes hanger 10 thus in effect moves from the plane of the page in the direction of the observer. This movement involves hook 12 meeting pipette 15 in the region of stem 13 thereof and removing adhesive drop 18 which has already escaped at the free end of the pipette. Pipette 15 is elastic for this purpose. The illustration shows a situation in which opening 16 of pipette 15 is adjusted in a position directly in front of stem 13. It is preferably provided that an overcrossing is provided prior to contact of pipette 15 and stem 13 such that stem 13 meets pipette 15 above opening 16. This also enables application of adhesive 17 in the case of oscillating clothes hangers 10 in which the stem is therefore not oriented in a precisely perpendicular direction, as shown in the illustration. For the embodiment of elastic pipette 15, one can imagine the illustration in FIG. 2 such that the movement of clothes hanger 10 along transporting direction 21 thereof is continued so far and the deflection of flexible pipette 15 is precisely to the point at which, at the next moment, adhesive drop 18 is transferred to stem 13.

FIG. 3 shows the situation in which a treated clothes hanger 10 is moved along transporting direction 21 thereof past pipette 15 and adhesive 17 has been applied to stem 13. Adhesive 17 is a capillary flowable adhesive 17 which wets the surface of stem 13 and flows in the direction of gap 20. The flow of adhesive 17 in the direction of gap 20 is brought about by the influence of gravity. In gap 20, the movement of adhesive 17 is due to the capillary flowability thereof. Hook 12 is once again blocked in body 11 after hardening of adhesive 17 in gap 20.

Due to the capillary flowability of adhesive 17, an adhesive drop 18 once again forms at opening 16 of pipette 15 after removal of an adhesive drop 18, whereby said adhesive drop 18 formed can then be applied to subsequent clothes hanger hook stem 13. There is therefore no need to transport adhesive 17. The adhesive applicator (not shown) thus comprises in the simplest case only pipette 15 and an adhesive reservoir. In this form, the adhesive applicator can be mounted on a frame element or the like of a transporting or sorting device such that the above-mentioned position of pipette 15 is produced relative to clothes hangers 10 respectively transported in a hanging manner. This results in a simple and efficient possibility for re-fixing clothes hanger hook 12 in respective clothes hanger body 11, thereby significantly improving the reusability of clothes hangers 10.

The present invention can therefore be summarized as follows: The present invention describes a method and a device provided for carrying out said method for fixing, in particular for re-fixing, clothes hanger hooks 12 in a clothes hanger body 11, whereby clothes hanger hook 12 is wetted, in particular in the region of a clothes hanger hook stem 13, with an adhesive 17 and adhesive 17 penetrates a gap 20 between clothes hanger hook 12 and clothes hanger body 11 in the region of a connecting point between clothes hanger hook 12 and clothes hanger body 11 such that the clothes hanger hook is glued in clothes hanger body 11.

List of Reference Numbers

10 Clothes hanger

11 Clothes hanger body, body

12 Clothes hanger hook, hook

13 Clothes hanger hook stem, stem

14 Line

15 Pipette

16 opening (of the pipette)

17 Adhesive

18 Adhesive drop

19 Bushing

20 Gap

21 Arrow (transporting direction)

1. A method for fixing, in particular for re-fixing, a clothes hanger hook (12) in a clothes hanger body (11), characterized in that the clothes hanger hook (12) is wetted in the region of a clothes hanger hook stem (1 ) with an adhesive (17) and in that, in the region of a connecting point between the clothes hanger hook (12) and the clothes hanger body (11), the adhesive (17) penetrates a gap (20) between the clothes hanger hook (12) and the clothes hanger body (11).

2. The method as claimed in claim 1, wherein the adhesive (17) is applied to the clothes hanger hook (12) with a pipette (15).

3. The method as claimed in claim 2, wherein the pipette (15) is elastic at a free end.

4. The method as claimed in claim 2, wherein the pipette (15) touches the clothes hanger hook in the region of the clothes hanger hook stem (13).

5. The device as claimed in claim 4, wherein the free end of the pipette is positioned and aligned in such a manner so as to produce an overcrossing with the clothes hanger hook stem (13).

6. The method as claimed in claim 1, wherein the adhesive (17) is a capillary flowable adhesive (17).

7. A device for fixing, in particular for re-fixing, a clothes hanger hook (12) in a clothes hanger body (11) of a clothes hanger (10), with an adhesive applicator which comprises a pipette (15) and which is assigned to a transporting device for transporting the clothes hangers (10), the pipette (15) being positioned with a free end in the region of a path of movement of the clothes hangers (10) in such a manner that, during the transporting of the clothes hangers (10), the pipette (15) with the free end successively in each case touches the clothes hanger hook (12).

8. The device as claimed in claim 7, wherein the pipette (15) is elastic at its free end.

9. The device as claimed in claim 7, wherein the pipette touches the clothes hanger hook (12) in the region of a clothes hanger hook stem (13).

10. The device as claimed in claim 9, wherein the free end of the pipette (15) is positioned and aligned in such a manner so as to produce an overcrossing with the clothes hanger hook stem (13).

11. The device as claimed in claim 7, wherein a capillary flowable adhesive (17) is applied with the pipette (15).

12. The method as claimed in claim 3, wherein the pipette (15) touches the clothes hanger hook in the region of the clothes hanger hook stem (13).

13. The device as claimed in claim 12, wherein the free end of the pipette is positioned and aligned in such a manner so as to produce an overcrossing with the clothes hanger hook stem (13).

14. The method as claimed in claim 13, wherein the adhesive (17) is a capillary flowable adhesive (17).

15. The device as claimed in claim 8, wherein the pipette touches the clothes hanger hook (12) in the region of a clothes hanger hook stem (13).

16. The device as claimed in claim 15, wherein the free end of the pipette (15) is positioned and aligned in such a manner so as to produce an overcrossing with the clothes hanger hook stem (13).

17. The device as claimed in claim 16, wherein a capillary flowable adhesive (17) is applied with the pipette (15).
